(19) United States
(12) Patent Application Publication
(10) Pub. No.: US 2015/0215914 A1
(43) Pub. Date: Jul. 30, 2015

(54) SOFTWARE-DEFINED NETWORKING METHOD

(71) Applicant: ELECTRONICS AND TELECOMMUNICATIONS RESEARCH INSTITUTE, Daejeon (KR)

(72) Inventors: Seung Hyun CHO, Daejeon (KR); Kyeong Hwan DOO, Daejeon (KR); Bin Yeong YOON, Daejeon (KR); Heuk PARK, Daejeon (KR); Sang Soo LEE, Daejeon (KR); Jong Hyun LEE, Daejeon (KR)

(21) Appl. No.: 14/605,278

(22) Filed: Jan. 26, 2015

(30) Foreign Application Priority Data
Jan. 24, 2014 (KR) 10-2014-0009156

(51) Int. Cl. H04W 72/04; H04W 28/10; H04L 12/721

(52) U.S. Cl. CPC H04W 72/042; H04L 45/38; H04W 28/10; H04W 24/08

(57) ABSTRACT

A software-defined networking (SDN) method. The SDN method according to an exemplary embodiment may be used in managing and operating SDN-based network resources in an optical communications network, a fixed mobile convergence subscriber network, a wired broadband subscriber network, a distributed mobile communications base station network, etc.

### CROSS-REFERENCE TO RELATED APPLICATION(S)

This application claims the benefit under 35 U.S.C. §119(a) of Korean Patent Application No. 10-2014-0009156, filed on Jan. 24, 2014, in the Korean Intellectual Property Office, the entire disclosure of which is incorporated herein by reference for all purposes.

### BACKGROUND

1. Field

The following description relates to software-defined networking technology.

2. Description of the Related Art

Software-defined networks (hereinafter referred to as SDN) suddenly being an issue in the telecommunications industry is a next-generation networking technology for setting and controlling the path of a network through software programming. Also, SDN allows for convenient and easy processing of its complicated operations and management.

To this end, in the SDN, a data plane and a control plane of the network are separated, and a standardized interface is provided therebetween. A network administrator may control, in various ways, a telecommunications function operated on the data plane by programming the control plane in accordance with various network situations.

Due to growth of the mobile terminal market, an increase of big data and high-definition content, and a suddenly increasing demand for a cloud-based virtualization service, and the like, a reassessment of the current network structure and management system is much need, especially because of problems such as changes in traffic patterns, the spread of virtualization technology, its congestion-causing complex structure, troubles with network management, vendor dependence, etc.

Changes in the networking environment and the discord between market demand and network elements are two main causes for the birth of SDN. SDN, combined with an OpenFlow protocol, can configure a complex path that could not be configured in the existing network. Also, SDN can effectively handle a change in traffic patterns. Moreover, SDN can quickly configure a virtual network that is needed in a cloud environment where creation, deletion, and movement of a virtual machine frequently occur. Furthermore, SDN can economically build a large capacity network and perform a function of a variable adaptive line rate.

### SUMMARY

The following description relates to a software-defined networking (SDN) method for processing large volumes of traffic on demand.

In one general aspect, an SDN method includes: a control device transmitting a control command, which includes defining a control parameter based on software in response to a traffic request of a node by monitoring a traffic flow, and transmitting a control command with respect to the software-defined control parameter to one or more nodes through a control channel by using an OpenFlow; and the one or more nodes executing the control command wherein the one or more nodes have received the control command from the control device.

In another general aspect, an SDN method in a fixed mobile convergence subscriber network includes: a control device transmitting a control command, which includes defining a control parameter based on software in response to a traffic request of a subscriber terminal device by monitoring a traffic flow, and transmitting a control command with respect to the software-defined control parameter to a device of a central base station through a control channel by using OpenFlow; the device of a central base station transmitting the control command received from the control device to each subscriber terminal device of a wired or wireless form through distribution of network resources; and the subscriber terminal device receiving the control command from the device of a central base station and executing the received control command.

In another general aspect, an SDN method in a mobile communications base station network based on analog wireless-optical transmission includes: a control device transmitting a control command to a digital unit (DU), which includes defining a control parameter based on software in response to a traffic request of a radio unit (RU) by monitoring a traffic flow, and transmitting a control command with respect to the software-defined control parameter to the DU through a control channel by using OpenFlow; the DU transmitting the control command received from the control device to each RU, converting a digital baseband signal to an analog signal in accordance with the control command, shifting upward the converted digital baseband signal to an intermediate frequency (IF) signal, multiplexing the IF signal, and transmitting the multiplexed IF signal to each RU; and each RU receiving and executing the control command, extracting the IF signal from the multiplexed IF signal received from the DU in response to the control command, converting the extracted IF signal into a high frequency signal, and transmitting the converted IF signal to free space.

Other features and aspects may be apparent from the following detailed description, the drawings, and the claims.

### BRIEF DESCRIPTION OF THE DRAWINGS

FIG. 1 is a diagram, according to an exemplary embodiment, illustrating a structure of an optical communications network where a concept of software-defined networking (SDN) for processing traffic on demand is applied.

FIG. 2 is a diagram, according to an exemplary embodiment, illustrating a structure about transmitting extended OpenFlow-based logical control commands between a control device and each of the nodes.

FIG. 3 is a diagram, according to an exemplary embodiment, illustrating a process of transmitting a traffic control command in an optical communications network in FIG. 2.

FIG. 4 is a diagram, according to an exemplary embodiment, illustrating a logical structure of a physical layer for transmitting an extended OpenFlow-based control commands between a control device and each of the sub nodes for cases in which a main node has a data transfer channel and a control channel which are separate from a sub node.

FIG. 5 is a diagram, according to an exemplary embodiment, illustrating a process of transmitting a traffic control command over a communications network in FIG. 4.

FIG. 6 is a diagram, according to an exemplary embodiment, illustrating a three-level structure of an optical network to which SDN concept have been applied.

FIG. 7 is a diagram, according to an exemplary embodiment, illustrating a structure of a fixed mobile convergence subscriber network or a wired broadband subscriber network where SDN concept has been applied.

FIG. 8 is a diagram, according to an exemplary embodiment, illustrating a structure about transmitting logical control commands in a fixed mobile convergence subscriber network or a wired broadband subscriber network, both of which are based on a time-division multiplexing-passive optical network (TDM-PON).

FIG. 9 is a control flowchart, according to an exemplary embodiment, illustrating of a fixed mobile convergence subscriber network or a wired broadband subscriber network in FIG. 8.

FIG. 10 is a diagram, according to an exemplary embodiment, illustrating a hierarchical position and a connection structure of a fixed mobile convergence access network among three layers of an optical network to which SDN concept has been applied.

FIG. 11A is a diagram, according to an exemplary embodiment, illustrating a mobile communications base station network structure using SDN-based analog wireless-optical transmission technology and multiplexing technology that uses an intermediate frequency.

FIG. 11B is a diagram, according to an exemplary embodiment, illustrating a limitation to bandwidth in a network structure in FIG. 11A.

FIG. 12 is a diagram, according to an exemplary embodiment, illustrating the transmission structure of logical control commands with respect to a mobile communications base station network which uses analog wireless optical transmissions and which can deal with traffic on demand.

FIG. 13 is a flowchart, according to an exemplary embodiment, illustrating a process of transmitting logical control commands in a mobile communications base station network that uses analog wireless-optical transmissions FIG. 12 and through which traffic on demand can be dealt.

FIG. 14 is a diagram, according to an exemplary embodiment, illustrating a structure of a mobile communications base station network that uses analog wireless optical transmissions and through which traffic on demand can be dealt with on demand.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

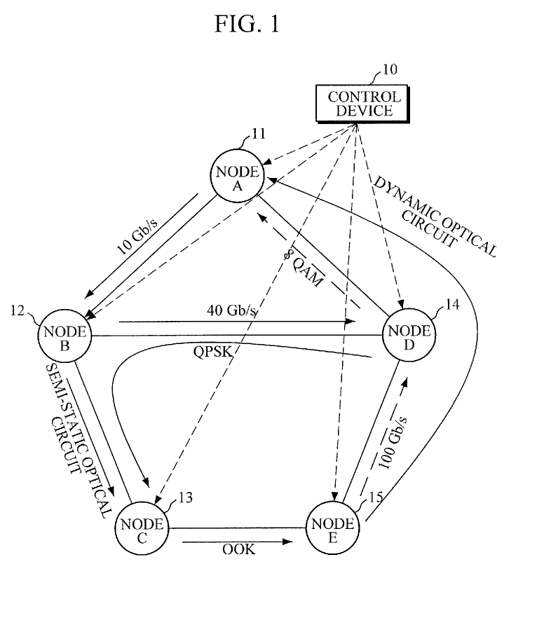

FIG. 1 is a diagram, according to an exemplary embodiment, illustrating a structure of an optical communications network where a concept of software-defined networking (hereinafter referred to as SDN) for processing traffic on demand has been applied.

Referring to FIG. 1, an optical communications network, according to the exemplary embodiment, includes five nodes A, B, C, D, and E 11, 12, 13, 14, and 15, each of which is connected in a semi-mesh form. For example, the transmission speed of traffic from node A 11 to node B 12 is 10 Gb/s, and a wavelength is λ1 whose transmission format supporting such a wavelength may be specifically designated. The traffic transmitted from the node D 14 to the node C 13 is performed through the switching of a semi-static circuit method and uses a quadrature phase-shift keying (QPSK) transmission format, and the amount of the traffic may be an arbitrary value. The traffic transmitted from the node C 13 to the node E 15 may be transmitted in an on-off keying (OOK) transmission format at a specific transmission speed.

All the processes described above operate through a control channel that is separate from the data channel according to the management policy of a control device 10 that monitors the network's performance in the center in real time. In an optical communications network where the concept of SDN is combined, the control device 10 monitors the movement of traffic at all times. If the control device 10 detects, at a specific time, a request for a change of the traffic acquired in consideration of a quality of service (QoS) policy while monitoring the movement of the traffic, the control device 10 responds to the request for a change of the traffic by using a concept of software-based management and control. For example, the control device 10 defines, based on software, control parameters related to the transmissions within a physical layer that is inside the optical communications network, and with these parameters, controls each of the nodes to maximize effectiveness.

A network in which the concept of SDN is combined operates based on various switching paradigms which are different from the existing network. That is, as the static switching is only available previously, not only the semi-static switching but also dynamic switching is available over the network where the SDN concept is combined. Thus, a more flexible control of the traffic is possible, which then leads to more efficient energy use, which ultimately means a reduction in the overall operating expenses

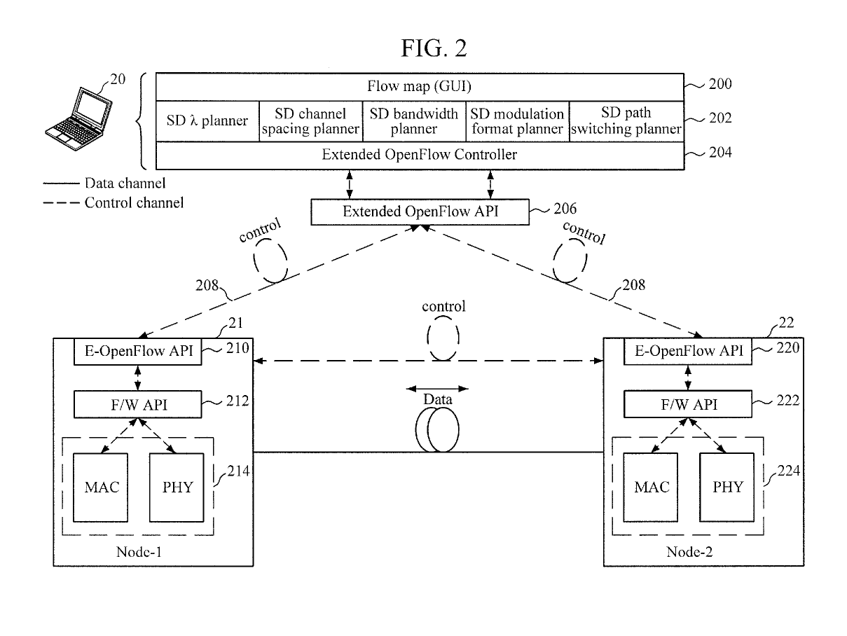

FIG. 2 is a diagram, according to an exemplary embodiment, illustrating a structure about transmitting extended OpenFlow-based logical control commands between a control device and each of the nodes.

Referring to FIG. 2, each of the nodes 21 and 22 is configured with function blocks that are capable of controlling wavelength conversions, transmission speed, modulation formats, channel intervals, path switching, etc., which are included in the network management resources. A control device 20 controls each function block of each of the nodes 21 and 22 by using an extended OpenFlow-based protocol.

The upper layer of the control device 20 is configured with GUI-format flow maps 200 for a flow control. The lower layer of each flow map 200 is configured with software-defined planners 202 for efficient control. For example, the software-defined planners 202 may include a software-defined wavelength conversion planner, a software-defined transmission speed planner, a software-defined modulation format planner, a software-defined path switching planner, etc.

An extended OpenFlow controller 204 is positioned in the lowest layer of the control device 20 to thereby transmit input control commands to each of the nodes 21 and 22 through extended OpenFlow application programming interfaces (hereinafter referred to as E-OpenFlow API) 206. E-OpenFlow APIs 210 and 220 of the nodes 21 and 22, respectively, converts a control command transmitted from the control device 20 into a programmable language and then relays it to each firmware 212 and 222, the ones in charge of controlling the hardware, so that actual actions may be carried out in nodes 21 and 22. Ultimately, each firmware 212 and 222 controls the operation of each hardware 214 and 224 related to a control command so as to enable appropriate actions to be performed according to the control command that was received.

What is important here is that a channel 208, which is used for transmitting control commands, exists separately as an add-on. The control channel 208 may have its physical path added and operated independently from a data transfer channel. Also, the control channel 208 may share the physical path but operate as separated logically. In such a case, the control channel 208 may additionally assign and manage physical layer network resources of a wavelength or frequency, etc. for the configuration of the control channel 208.

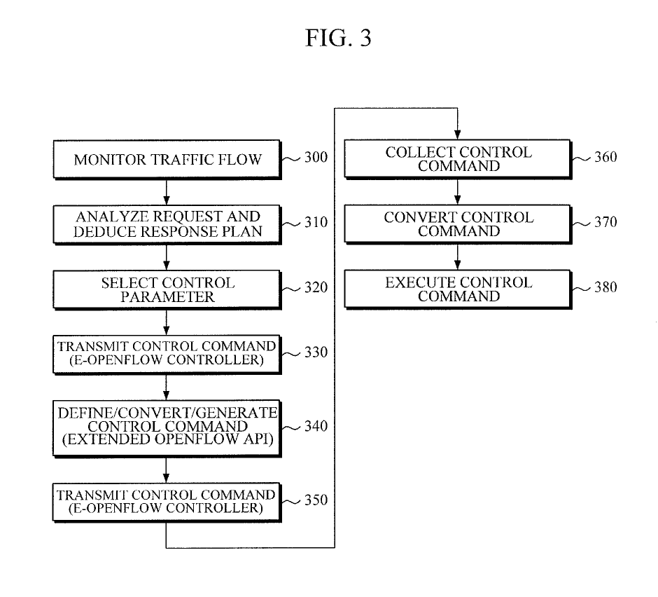

FIG. 3 is a diagram, according to an exemplary embodiment, illustrating a process of transmitting a traffic control command in an optical communications network in FIG. 2.

Referring to FIGS. 2 and 3, a control device 20 checks a request by monitoring a traffic flow through a flow map 200 in 300. If the control device 20 receives a request for a traffic change from any node while monitoring the traffic flow, the control device 20 analyzes the current management status of resources in the entire network and deduces a response plan appropriate for the request in 310.

Subsequently, the control device 20 defines, based on software, a control parameter through software-defined planners 202 in 320. The control parameter may be network resources for a physical layer transmission, such as a wavelength conversion, a transmission speed, a modulation format, path switching, etc. In addition, an E-OpenFlow API 206 transmits a control command to each of nodes 21 and 22 through a control channel 208 by the control by the extended OpenFlow controller 204 in 330 and 350. Each of the nodes 21 and 22 collects the control command in 360 through E-OpenFlow APIs 210 and 220, converts the control command into a programmable language in 370, and transmits the control command to each firmware 212 and 222 which are in charge of the control within a hardware so as to enable the control command to be operated indeed in each of devices, and each firmware 212 and 214 finally control operations of each hardware 214 and 224 related to the control command to thereby execute the control command in 380 so that the operations appropriate for the indeed transmitted control command are performed.

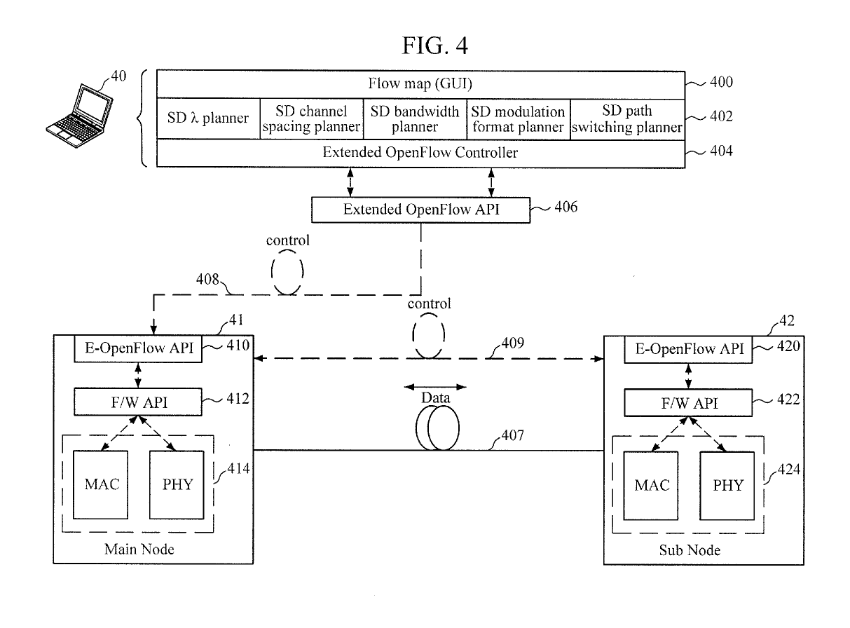

FIG. 4 is a diagram, according to an exemplary embodiment, illustrating a logical structure of a physical layer for transmitting an extended OpenFlow-based control commands between a control device and each of the sub nodes for cases in which a main node has a data transfer channel 407 and a control channel 409 which are separate from a sub node.

FIG. 4 specifically illustrates a network configuration with respect to a physical layer parameter of a case in which a sub-node 42 does not have a control channel that is directly connected to a control device 40 and is connected to the control device 40 through a control channel 409 formed to be connected to a main node 41.

Referring to FIG. 4, in a network according to an exemplary embodiment different from the network described above with reference to FIG. 2, the sub-node 42 is not directly connected to the control device 40 but has a data transfer channel and a control channel which are separate and independent from the control device 40 due to a main node 41. In order to help the reader in his comprehension, in FIG. 4, a method of connection between the main node 41 and the sub-node 42 is illustrated as having a 1:1 connection structure. However, a 1:N connection structure is also possible.

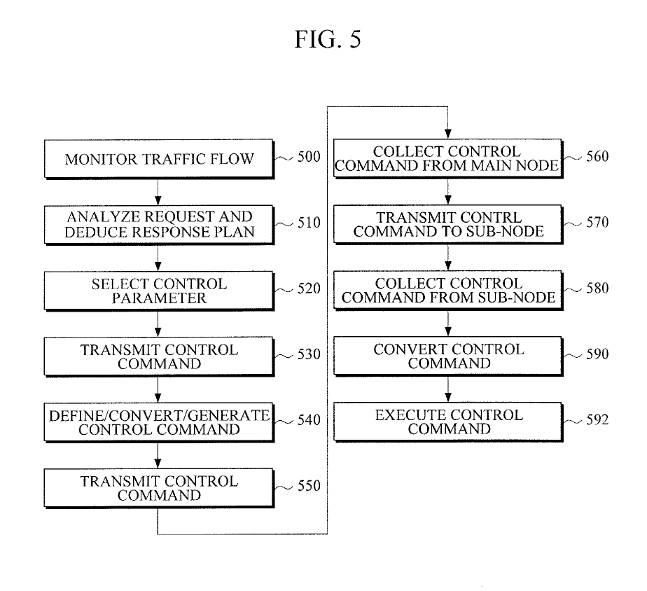

FIG. 5 is a diagram, according to an exemplary embodiment, illustrating a process of transmitting a traffic control command over a communications network in FIG. 4.

FIG. 5 is a detailed illustration of a flowchart for controlling physical layer transmission parameters of a sub-node 42 by using an extended OpenFlow-based control protocol and a control channel between a main node 41 and the sub-node 42.

Most control flows 500, 510, 520, 530, 540, 550, 590, and 592 are not much different from the control flows mentioned above with reference to FIG. 3. However, FIG. 5 further includes collecting a control command from the main node 41 in 560, transmitting the control command to the sub-node 42 in 570, and collecting the control command from the sub-node 42 in 580, for which such operations are needed for transmitting a control signal from the main node 41 to the sub-node 42.

Three of these added operations 560, 570, and 580 do not require additional special functions and perform the simple role of re-transmission for the smooth transmission of an extended OpenFlow-based control signal. Thus, the control device 40 may control primary functions related to the physical layer transmission of the main node 41 and the sub-node 42 through the processes described above, and in addition, perform the control command appropriate for requests of traffic that changes every moment for each of nodes 41 and 42.

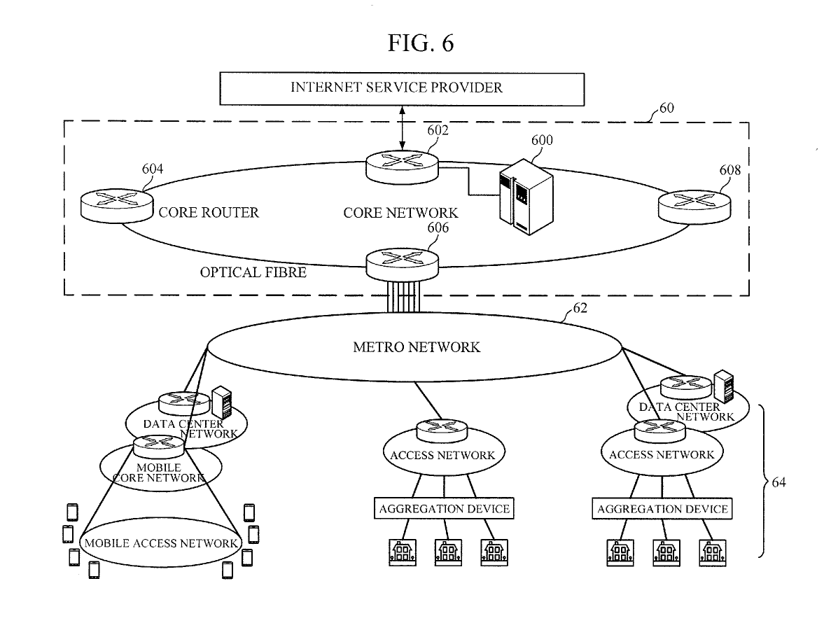

FIG. 6 is a diagram, according to an exemplary embodiment, illustrating a three-level structure of an optical network to which SDN concept have been applied.

FIG. 6 specifically illustrates the optical network, to which an SDN concept have been applied and which is divided into a three-level structure that consists of a core network 60, a metro network 62, and an access network 64. Correlations and roles between various types of networks that are described later through a description referring to FIG. 6 are required to be defined precisely.

Referring to FIG. 6, an SDN-based optical communications network according to an exemplary embodiment indicates a core network 60. By using a software-defined control command of an upper application form, a control device 600 in the core network 60 automatically or semi-automatically changes quantitative and qualitative characteristics of the traffic that is added, extracted, or switched for each of nodes 602, 604, 606, and 608 according to a change for requests for each of the nodes 602, 604, 606, and 608 with respect to backbone traffic.

What is important here is that a data channel for each of the nodes 602, 604, 606, and 608 is connected usually with optical fibers, and a control channel between the control device 600 and each of the nodes 602, 604, 606, and 608 is connected using a method of configuring various communications paths including the optical fibers. As examples of the method of configuring a communications path, there is wireless transmission using an RF signal or a visible light communication method, etc. However, the examples are not limited thereto. Furthermore, each of the nodes 602, 604, 606, and 608 may be directly connected through the control device 600 and a control channel, or be connected between a specific main node and the control device 600 through a control channel with a concept of a main node and a sub-node. Here, what is characteristic here is that there is a stand-alone control channel between be main node and the sub-node.

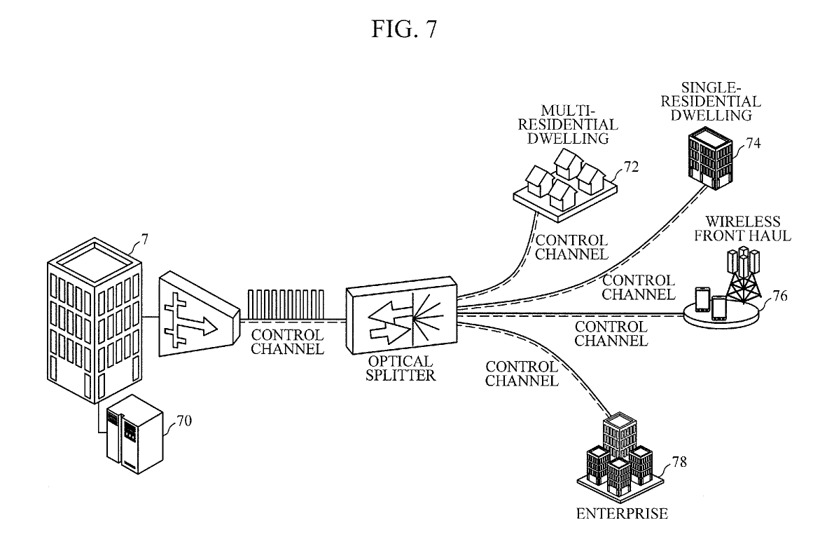

FIG. 7 is a diagram, according to an exemplary embodiment, illustrating a structure of a fixed mobile convergence subscriber network or a wired broadband subscriber network where SDN concept has been applied.

Recently, there are efforts underway to combine the wired subscriber network infrastructure and a wireless subscriber network infrastructure to build, operate, and manage the combined infrastructure due to a rapid revitalization of a mobile communications service. Under these efforts, capital expenditures (CAPEX) and operating expenditures (OPEX) of a communications service provider are reduced so as to ultimately improve average revenue per user (ARPU) in a provider's position. Particularly, some attempts for combining, into a single infrastructure, wired superspeed optical subscriber network and a front-haul network of a mobile communications base station with much homogeneity and managing the infrastructure, partially begin or some setups thereof are already completed to execute a commercial service. In order to build a wired service subscriber network in such a fixed wireless convergence subscriber network, a passive optical network (PON) technology is usually used, which is a core technology, and above all, technologies are usually used, such as time-division multiplexing (TDM), wavelength-division multiplexing (WDM), orthogonal frequency-division multiplexing (OFDM), sub-carrier multiplexing-PON (SCM-PON), etc.

In the PON technology, dividing physical network resources to make upper or downward communications with each of the subscribers is usual. The communications are performed by assigning, for each of the subscribers, a time slot in TDM-PON; a wavelength in WDM-PON; an orthogonal frequency in OFDM-PON; and a sub-carrier of a frequency domain in SCM-PON. Generally, physical network resources are properly distributed to be appropriate for the wired subscribers' requests for the bandwidth so as to communicate with a telephone station (a central base station). But recently, systems that request transmission of large traffic volumes, such as a fourth generation mobile communications system may assign, to each of the base stations, a quantity of traffic that is similar to a quantity of the traffic that has been assigned for each of the subscribers in an existing wired subscriber network. Accordingly, the system for requesting transmission of large traffic directly converts some distribution networks, which configure the wired subscriber network, into a front-haul network required for the operation of a mobile communications base station system and then uses it. Thus, network resources such as a time-slot, a wavelength, an orthogonal frequency, and a sub-carrier, etc., which are mentioned above, begin to be used in the traffic transmission of a mobile communications base station system.

Such a network is commonly called a fixed mobile convergence subscriber network. A fixed mobile convergence subscriber network, in which SDN concepts are applied, includes a control device 70 for execution of the SDN in a central base station 7 as illustrated in FIG. 7. The wired broadband subscriber network is structurally the same as the fixed mobile convergence subscriber network. However, the mobile communications base station system is not built as a subordinate system at the end of the distribution network, which is, however, all configured only as a wired subscriber terminal device.

The control device 70 monitors the movement of traffic at all times according to the subscriber's terminal and the service type thereof, which is separately connected to the PON distribution network. In a case where an increase or decrease of the traffic is requested in a terminal or system connected to a specific distribution network, the control device 70 may identify the current management status of resources in the entire network and take measures to respond appropriately to the requests.

FIG. 7 illustrates a network 72 for a multi-residential environment, a network 74 for a single-residential environment, and a network 78 for an enterprise environment, and so on, as wired broadband subscriber networks. Also, an example is given of a wireless front-haul network 76 as a wireless subscriber network.

For example, it is generally assumed that in an enterprise network 78, approx. 100 Gb/s is needed for traffic requests. In such a case, the control device 70 assigns a random single or multiple wavelengths or frequency resources and then selects a specific modulation method so that a traffic volume of 100 Gb/s may indeed be transmitted. To this end, the control device 70 defines, based on software, a path, a wavelength, a time or frequency assignment, a modulation method, channel bandwidth and interval, etc., and configures a transmission environment so as to perform the relevant functions.

In another example, for managing a distribution network where there is a mobile communications base station, the control device 70 performs the management and control of the base station system appropriate for the wireless front-haul network 76. For example, during the daytime, the control device 70 assigns the proper wavelength (or frequency and time) resources so as to enable the processing of a traffic volume 10 Gb/s so as to process large traffic volume requested by a plurality of mobile communications subscribers. Also, in order to process target traffic requests, the control device 70 uses a 16 quadrature amplitude modulation (QAM) method which is one of methods of increasing the symbol rate and enhancing spectroscopic transmission efficiency.

However, compared to the day, less than 10% of traffic requests are generated during night time, and as such, the control device 70 assigns the proper wavelength (or frequency and time) resources so as to enable the processing of 1 Gb/s traffic volume. At this time, the control device 70 processes the target traffic using on-off keying (OOK) modulation method that reduces the symbol rate. All the processes mentioned above are performed through the monitoring and control of the control device 70 located in a central base station 7. Furthermore, all transmissions of control commands and executions thereof are done through the respective control channel paths related thereto.

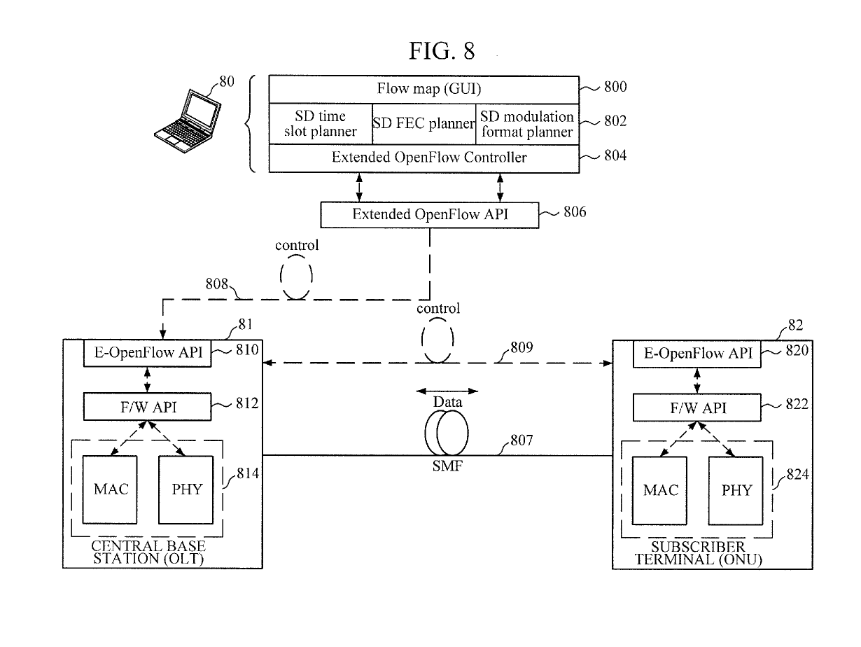

FIG. 8 is a diagram, according to an exemplary embodiment, illustrating a structure about transmitting logical control commands in a fixed mobile convergence subscriber network or a wired broadband subscriber network, which is based on a time division multiplexing-passive optical network (TDM-PON).

FIG. 8 illustrates in detail a logical structure of a fixed mobile convergence subscriber network, to which SDN concepts have been applied for traffic control and which is capable of performing control and monitoring command functions related thereto. Particularly, FIG. 8 illustrates a structure for transmitting a logical control command of a fixed mobile convergence subscriber network. The fixed mobile convergence subscriber network, to which SDN concept has been applied, is based on a TDM-PON-based fixed mobile convergence subscriber network, such as gigabit capable passive optical network (GPON) and gigabit Ethernet passive optical network (GEPON) that are currently used widely.

Referring to FIG. 8, a central base station (Optical Line Terminal: OLT) 81 and a subscriber terminal (Optical Network Unit: ONU) 82 have, respectively, each hardware 814 and 824, each of which includes a physical layer (PHY) functional block and a media Access Control (MAC) functional block which are variably controllable with respect to each network management resource, such as a time slot, a modulation format, forward error correction (FEC) code, etc., which belong to the network management resources.

A control device 80 controls each of these functions by using a protocol based on an extended OpenFlow. Flowever, the variable functions mentioned here are only examples and does not indicate any limitation to specific functions.

The upper layer of the control device 80 is configured with a flow map 800 of a GUI form for flow control, and in the lower layer of each flow map 800, software-defined planners 802 are positioned for an efficient control. The software-defined planners 802 may include a software-defined time slot planner, a software-defined modulation format planner, a software-defined forward error correction (FEC) code planner, etc.

In a case of a WDM-PON, the planners 802 may include a software-defined wavelength planner, a software-defined modulation format planner, a software-defined wavelength interval planner, etc. In the case of OFDM-PON, the planners 802 may include a software-defined OFDM sub-carrier planner, a software-defined modulation format planner, a software-defined fast Fourier transform (FFT) size planner, a bandwidth planner, etc.

In the lowest layer of the control device 80, an extended OpenFlow controller 804 is positioned to be connected to the extended OpenFlow (E-OpenFlow) API 806 so that the input control command is transmitted respectively to the central base station (OLT) 81 or the subscriber terminal (ONU) 82.

The E-OpenFlow 810 converts, into a programmable language, the control command received from the control device 80 and transmits the converted control command to firmware 812 which are in charge of a control within hardware so as to enable the control command to be practically operated in each device. The firmware 812 finally controls operations of hardware 814 related to the control command so as to enable operations appropriate for the practically transmitted control command to be performed.

Here, the important matter is that a physical channel for transmitting the control command is separated. The control channel 208 may have its physical path operated independently from a data transfer channel and, and share the physical path but be operated as logically separate. In such a case, physical layer network resources, such as a wavelength or frequency, etc., for a configuration of the control channel are assigned and operated.

FIG. 8 illustrates an example not using a structure of configuring the network by separating the control channels from a plurality of control devices 80 that directly connect the single central base station (OLT) 81 and the multiple subscriber terminals (ONU) due to the nature of a subscriber network but using simply a point-to-multi-point (P2MP) connection structure between the central base station (OLT) 81 and the subscriber terminals (ONU) 82 without a change. That is, by using an additional wavelength, time slot, or frequency, etc., a logical control channel 809 is generated additionally within a data channel 807 between the central base station (OLT) 81 and the subscriber terminal (ONU) 82 whose is settings are both already completed, and a functional control of the subscriber terminal (ONU) 82 is executed through the central base station (OLT) 81.

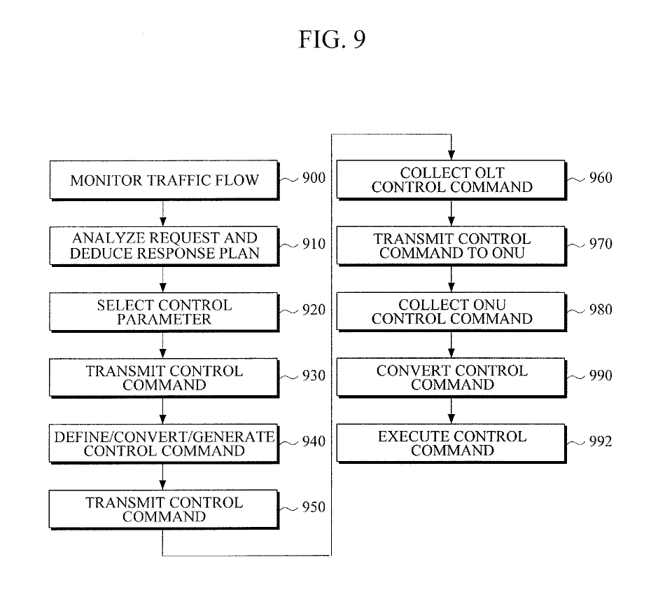

FIG. 9 is a control flowchart, according to an exemplary embodiment, illustrating a fixed mobile convergence subscriber network or a wired broadband subscriber network in FIG. 8.

Specifically, FIG. 9 shows a process for controlling, by a control device 80, physical layer transmission parameters of a subscriber terminal (ONU) 82 through a control channel 809 connected to a central base station (OLT) 81 by using an extended OpenFlow-based control protocol and the control channel 809 between the central base station (OLT) 81 and the subscriber terminal (ONU) 82 in a system with the same structure as illustrated in FIG. 8.

Most control flows 900, 910, 920, 930, 940, 950, 990, and 992 are not much different from control flows mentioned above with reference to FIGS. 3 and 5. However, FIG. 9 additionally includes operations of collecting an OLT control command in 960, transmitting a control command to the ONU in 970, and collecting an ONU control command in 980 which are needed for transmitting a control signal from the central base station (OLT) 81 to the subscriber terminal (ONU) 82. Three of these added operations do not include specific additional functions, and perform a simple role of a re-transmission for the smooth transmission of an extended OpenFlow-based control signal. The control device 80 may control main functions related to a physical layer transmission of the central base station (OLT) 81 and the subscriber terminal (ONU) 82 through the above-mentioned control process. Further, the control device 80 may transmit the control command appropriate for requests of traffic that changes every moment for each of the central base station (OLT) 81 and the subscriber terminal (ONU) 82.

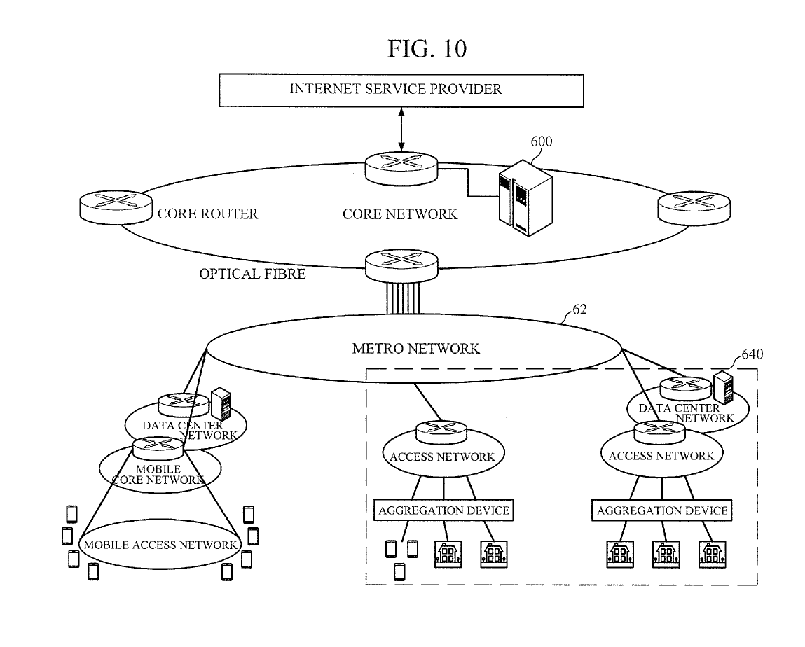

FIG. 10 is a diagram, according to an exemplary embodiment, illustrating a hierarchical position and a connection structure of a fixed mobile convergence access network among three layers of an optical network to which SDN concept has been applied.

Referring to FIG. 10, an SDN-based fixed mobile convergence subscriber network according to an exemplary embodiment indicates an access network 640. As illustrated in FIG. 10, the access network 640 may check that a wired subscriber device and a wireless subscriber device are converged.

According to situations by using a control command of a software-defined upper application form, the control device 600 automatically or semi-automatically changes quantitative and qualitative characteristics of traffic provided for each of the subscribers according to a traffic flow at the entire network level with regard to the traffic requested for each of the subscribers

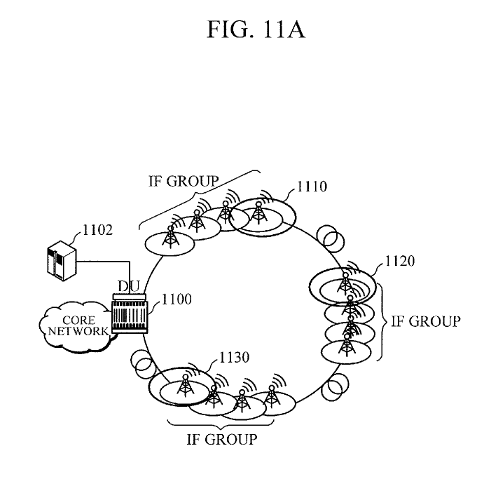

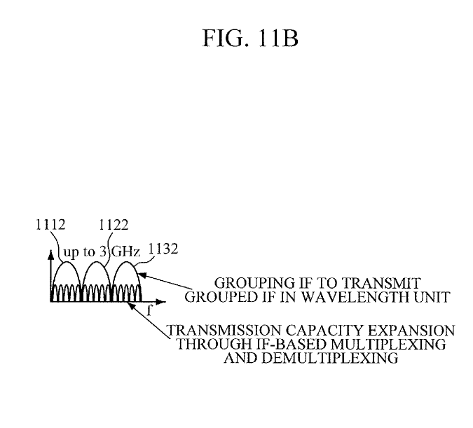

FIG. 11A is a diagram illustrating a mobile communications base station network structure using SDN-based analog wireless-optical transmission technology and multiplexing technology that uses an intermediate frequency.

Recently, due to fast dispersion of a third-generation and fourth-generation mobile communications service and its market, mobile communications service subscribers using mobile terminals explosively increase. Thus, an existing mobile communications base station system has limitation to a traffic processing capacity for supporting explosively increasing subscribers. One method of improving this is a distributed antenna system (DAS), and most of the base stations may be built based on the DAS in the near future. However, even such a DAS is not capable of catching up with a trend to increase a bandwidth of a fast advancing mobile communications service, thus being predicted to reach the limit of the traffic processing capacity sooner or later.

One of technologies to innovatively improve this problem is an analog wireless-optical transmission technology. The existing analog wireless-optical transmission technology directly modulates data to a carrier wave of an RF region directly used in a mobile communications service and transmits optically the modulated data. However, such a method does not have excellent effects in reducing the implementation and operation costs, and has a performance problem that a link budget is limited depending on a usage of a high frequency when the data is transmitted.

Thus, analog wireless-optical transmission and intermediate frequency (IF) multiplexing transmission technologies receive attention these days. Here, the analog wireless-optical transmission and intermediate frequency (IF) multiplexing transmission technology is regarding a technology of converting, by a digital unit (hereinafter referred to as DU), a mobile communications service signal to an IF to transmit the converted mobile communications service signal to a radio unit (hereinafter referred to as RU) in an optical area, and again converts the transmitted mobile communications service signal to an RF carrier wave appropriate for the mobile communications service to propagate the converted mobile communications service signal to free space in the RU that is an end of a base station. Realizing the analog wireless-optical transmission and IF multiplexing transmission technology has advantages of cheap implementation costs and making a base station system large in terms of capacity and wide in terms of an area. Hence, the analog wireless-optical transmission and IF multiplexing transmission technology is evaluated to be appropriate as a front-haul technology only used for a mobile communications base station used for post-fourth-generation or fifth-generation mobile communications systems. However, new technical problems of making multiple DUs large in terms of capacity to manage the DUs and controlling and managing parameters related to transmission performances of various types of physical layers so as to improve transmission characteristics of the multiple RUs may occur.

Means for improving the above-mentioned problems is applying an SDN concept to a DAS-based base station system used for mobile communications. If the SDN concept has been applied, a wavelength for wireless-optical transmission, an IF, a bandwidth, and an OFDM-related parameter and modulation method, etc., for mobile communications system may be more easily controlled and managed in a software-defined method. Hence, necessary expenses may be innovatively improved at a system operating level, and furthermore, the network resources may be operated effectively so as to be suitable for a traffic quantity requested for each of the RUs (antennas within the DAS system).

To execute the above-mentioned concept, a mobile communications base station system according to an exemplary embodiment may form a control device 1102 in a centralized large capacity DU 1100. The DU 1100 is connected to the control device 1102 through a control channel that is separate. The DU 1100 is connected to each of the RUs 1110, 1120, and 1130 through a control channel generated by using an additional wavelength or an intermediate frequency, etc., within a physical connection path.

In an analog wireless-optical transmission-based mobile communications base station system, a single DU 1100 of a large capacity is connected to multiple RUs 1110, 1120, and 1130 by using transmission media, such as optical fibers. In configuring the connection between the single DU 1100 and the multiple RUs 1110, 1120, and 1130, various topologies may be applied according to a provider's environment and a present distribution condition of base stations. For example, FIG. 11A illustrates a ring type topology but is only a simple example and may be indeed configured in various forms, such as bus, star, point-to-point topologies, etc., which implements an access structure of 1:N. In a case of the ring type, the multiple RUs 1110, 1120, and 1130 are connected with optical fibers around the DU 1100 of large capacity in the center. The optical fibers used here may be a single-mode optical fiber, a multiple-mode optical fiber, and a plastic optical fiber.

Such a distributed antenna system (DAS) may be applied to not only building a base station used for an existing mobile communications system but also building a short-distance DAS within a house or a building. In a system accepting a relatively short distance, the multiple-mode optical fiber or the plastic optical fiber may be used as transmission media as needed.

Referring to FIG. 11A, for making the analog wireless-optical transmission-based mobile communications base station system large, a method of multiplexing the IF is used. For example, for basically transmitting a signal with a maximum of approx. 20 MHz bandwidth between the DU and RUs, an LTE mobile communications system whose commercial service is currently activated converts the signal into a maximum of a 10 Gb/s digital signal and transmits the signal. In such a case, it is sure that network building and operating expenses increase due to an excessive bandwidth. To make these expenses low, in a case where the DU employs a structure of converting, into an analog signal, a digital baseband orthogonal frequency-division multiplexing (OFDM) signal that exists in a 20 MHz band and directly multiplexing the converted digital baseband OFDM signal into multiple analog signals in a frequency domain so as to transmit the multiplexed digital baseband OFDM signal, the network building and operating expenses may be innovatively reduced.

To this end, the DU shifts upward, into a specific IF signal, the OFDM-based LTE signal that is converted into an analog signal within a single wavelength and multiplexes the upward-shifted OFDM-based LTE signal in a frequency domain so as to transmits optically the multiplexed OFDM-based LTE signal. On the contrary, when received, the RU photoelectric-transforms the signal that is optically received while the IF is loaded and extracts the IF through shifting-downward of the frequency. After the IF goes through a specific proper filtering process and an amplifying process so as to be appropriate for free space transmission, the RU shifts upward again the IF into an RF carrier frequency that is set as a target. Thus, as many as (the number of acceptable wavelengths)×(the number of IF carriers capable for being multiplexed for each wavelength) in the entire system, the number of the RUs that the single DU is capable of accepting is derived. For example, if the system is capable of accepting 80 wavelengths and multiplexing 48 IFs, the single DU may accept 3,840 RUs. The total number of the IFs and its interval and bandwidth, etc., between each of the IFs, which are loaded in the single wavelength, are not limited to the exemplary embodiments mentioned above.

The control device 1102 monitors a traffic flow at all times according to a subscriber terminal and its service type which is separately connected to a mobile communications base station distribution network. In a case where an increase or decrease of the traffic is requested in a terminal or a system which is connected to a specific distribution network, the control device 1102 may identify the current management status of resources managed in the entire network and deduce a response plan appropriate for the requests.

For example, if the RU-1 1110 manages a system of 3 FA, 3 SECTOR, and 8×8 multiple-input multiple-output (MIMO), the traffic corresponding to such a system is requested to the control device 1102. In such a case, by assigning a specific single- or multiple-wavelength or IF resources and selecting a specific modulation method, the control device 1102 configures a transmission environment by software-defining and controlling a wavelength, the IF assignment, a modulation method, a channel bandwidth, an orthogonal frequency-division multiplexing (OFDM)-related parameter, etc., so as to transmit a quantity of currently requested traffic.

In another example, for the RU-2 1120 with 2 FA and 2 SECTOR, the control device 1102 properly assigns the wavelength and the IF resources appropriate for the RU-2 1120 to enable target traffic to be processed. In yet another example, for the RU-3 1130 that manages a system of 2 FA, 2 SECTOR, and 8×8 MMO, the control device 1102 properly assigns the wavelength and the IF resources to enable the traffic appropriate for the RU-3 1130 to be processed with respect to the target traffic. All the above-mentioned processes are performed through the control channel for monitoring the control device 1102 and transmitting the control command.

FIG. 11B is a diagram, according to an exemplary embodiment, illustrating limitation to bandwidth in a network structure in FIG. 11A.

The network structure according to an exemplary embodiment in FIG. 11A ensures price competitiveness of the entire system according to limitation to the number of the IFs and the modulation bandwidth, etc., by using a direct modulation laser (DML). For example, as illustrated in FIG. 11B, a modulation bandwidth is limited so as to enable the IF to occupy a domain that is less than 3 GHz. In a graph of FIG. 11B, a numeral reference 1112 indicates grouping the IF in the IF group including the RU-1 1110 of FIG. 11A to transmit the grouped IF in a wavelength unit; a numeral reference 1122 indicates grouping the IF in the IF group including the RU-2 1120 of FIG. 11A to transmit the grouped IF in a wavelength unit; a numeral reference 1122; and a numeral reference 1132 indicates grouping the IF in the IF group including the RU-3 1130 of FIG. 11A to transmit the grouped IF in a wavelength unit; a numeral reference 1122. In a case where a system with even larger capacity is desired to be implemented, an exterior modulator may be used. Here, the acceptance number of the IFs and the bandwidth, etc., may be freely determined within an available modulation bandwidth of the exterior modulator.

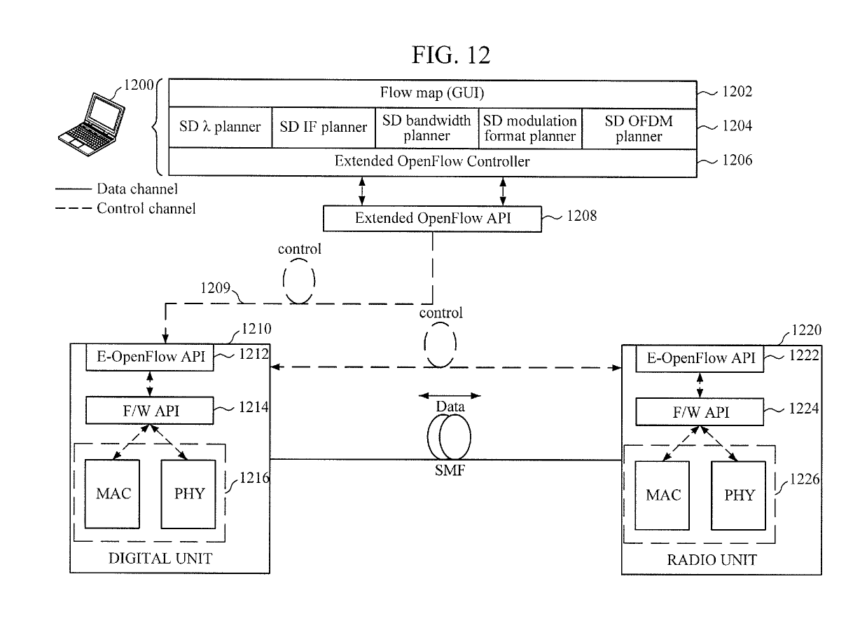

FIG. 12 is a diagram, according to an exemplary embodiment, illustrating the transmission structure of logical control commands with respect to a mobile communications base station network which is based on analog wireless-optical transmissions and which can deal with traffic on demand.

FIG. 12 specifically illustrates a logical structure of transmitting a control command with respect to an analog wireless-optical transmission-based mobile communications base station network where traffic on demand is processible by applying an SDN concept for the traffic control and performing functions of a specific control and a monitoring command related thereto.

A DU 1210 and an RU 1220 include each hardware 1216 and 1226 that include functional blocks of a physical layer (PHY) and a media access control (MAC), each of which is variably controllable in relation to network resources, such as a wavelength, an IF, a bandwidth, a modulation method, an OFDM-related parameter, etc. However, the variable functions mentioned here are only examples and does not indicate any limitation to specific functions.

A control device 1200 controls each of the DU 1210 and the RU 1220 by using an extended OpenFlow-based protocol. An upper layer of the control device 1200 is configured with flow map 1202 of a GUI form for a flow control, and a lower layer of each flow map 1202 is configured with software-defined planners 1204 for an efficient control. For example, the software-defined planners 1204 may include a software-defined wavelength planner, a software-defined IF planner, a software-defined bandwidth planner, a software-defined modulation format planner, a software-defined OFDM planner, etc. In the lowest layer of the control device 1200, an extended OpenFlow-based controller 1206 is positioned to be connected to an extended OpenFlow API 1208 so that an input control command is transmitted for each of the DU or RUs.

The E-OpenFlow API 1208 transmits the control command to the E-OpenFlow API 1210 of the DU 1210 through a control channel 1209, and the E-OpenFlow API 1210 of the DU 1210 converts the received control command into a programmable language and transmits the converted control command to firmware 1214 which is in charge of a hardware control so as to enable the control command to be practically operated in the DU 1210. The firmware 1214 finally controls operations of hardware 1216 related to the control command so as to enable appropriate operations to be performed according to the practically transmitted control command.

Here, the important matter is that a physical channel for the control command exists additionally as separate. In the control channel, a physical path may be operated independently from a data transfer channel, and share the physical path but be operated as separated logically. In such a case, physical layer network resources of a wavelength or an IF, etc., may be additionally assigned and managed for the configuration of the control channel 208.

FIG. 12 illustrates an example not using a connection structure of independently configuring the network by separating the control channels from a plurality of the control devices 1200 that connect directly the single DU and the multiple RUs due to the nature of a distributed antenna system (DAS)-based mobile communications base station network but simply using a bus-typed connection structure between the DU 1210 and the RUs 1220. That is, by using an additional wavelength, and IF, etc., a logical control channel is built additionally within a data channel between the DU 1210 and the RUs 1220 whose settings for a control parameter are both already completed, and a functional control of each of the RUs 1220 may be performed by the DU 1210.

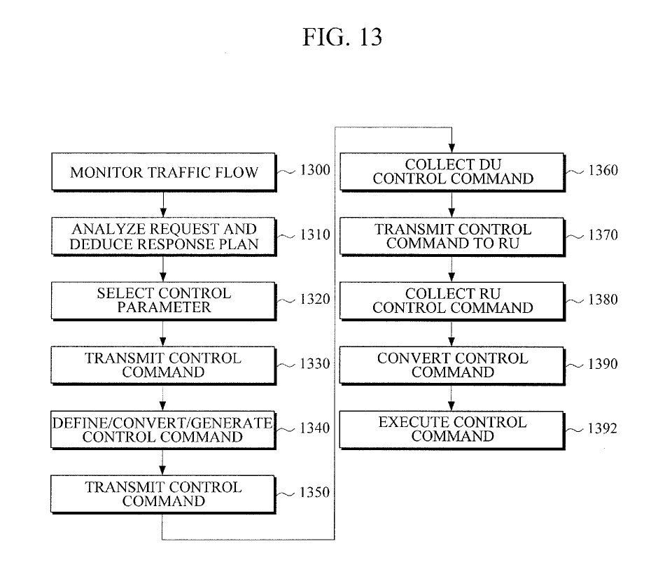

FIG. 13 is a flowchart, according to an exemplary embodiment, illustrating a process of transmitting logical control commands in a mobile communications base station network that uses analog wireless-optical transmissions in FIG. 12 and through which traffic on demand can be dealt with.

Referring to FIGS. 12 and 13, a control device 1200 controls physical layer transmission parameters of an RU 1220 through a control channel 1209 connected to a DU 1210 by using an extended OpenFlow-based control protocol and a control channel between the DU 1210 and the RU 1220. Most of control flows 1300, 1310, 1320, 1330, 1340, 1350, 1390, and 1392 are not much different from the control flows mentioned above. However, FIG. 13 further includes operations of collecting a control command in the DU 1210 in 1360, transmitting the control command to the RU 1220 in 1370, collecting the control command from the RU 1220 in 1380, etc.

Three of these added operations 1360, 1370, and 1380 do not require additional special functions, etc., and performs only a simple role of a re-transmission for the smooth transmission of an extended OpenFlow-based control signal. Thus, the control device 1200 may control primary functions related to a physical layer transmission between the DU 1210 and the RU 1220 through the processes described above, and in addition, may transmit the control command appropriate for requests of traffic that changes every moment for each of the RU 1220 and the DU 1210.

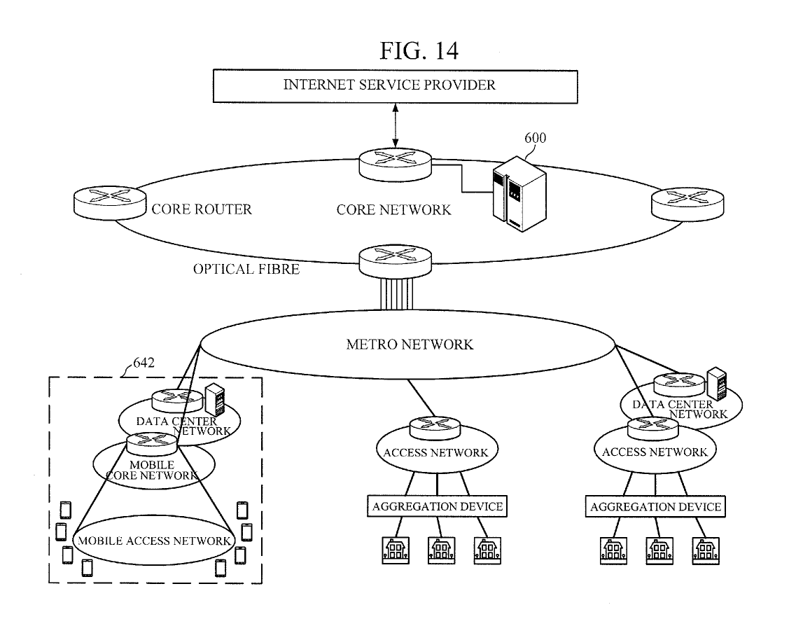

FIG. 14 is a diagram, according to an exemplary embodiment, illustrating a structure of mobile communications base station network that uses analog wireless-optical transmission and through which traffic on demand can be dealt with.

Specifically in FIG. 14, a wireless-optical transmission-based mobile communications base station network indicates a mobile core or access network 642 in a network divided into three steps of core/metro/access so as to easily identify a location of a mobile communications base station network to which an SDN-based wireless-optical transmission concept is applied. Here, according to situations by using a control command of a software-defined upper application form, a control device 600 automatically or semi-automatically changes quantitative and qualitative characteristics of traffic that is provided to each RU according to the traffic requested for each of the RUs and a traffic flow at the entire network level.

A current network structure and management structure is required to be reviewed because of technological and economic issues, such as the growth of mobile devices and the large and high-definition content and an increasing demand for a cloud-based virtualization service. To solve this, in the present disclosure, the SDN structure used in an upper layer is extended to be applied to a lower physical layer.

Accordingly, in addition to basic advantages of an SDN-based networking structure, the present disclosure may be capable of efficiently controlling and managing a transmission parameter in a physical layer. Eventually, the present disclosure is capable of configuring and managing a network suitable for transmission of video content, such as on-demand high-definition content, etc., having burst characteristics.

Furthermore, since SDN-based network resources are capable of being managed and operated in an optical communications network, a fixed mobile convergence subscriber network, a wired broadband subscriber network, a distributed mobile communications base station network, etc., the present disclosure is capable of flexibly responding to requests for traffic changes of an individual subscriber or a base station, etc., and simply and economically improving the transmission performance and increasing the capacity.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A software-defined networking (SDN) method in an optical communications network, the SDN method comprising:
a control device transmitting a control command, comprising:
defining a control parameter based on software in response to a traffic request of a node by monitoring a traffic flow, and transmitting a control command with respect to the software-defined control parameter to one or more nodes through a control channel by using an OpenFlow; and
the one or more nodes executing the control command, wherein the one or more nodes have received the control command from the control device.

2. The SDN method of claim 1, wherein the control parameter is related to physical layer transmission, which comprises at least one of a wavelength conversion, a channel interval, a bandwidth, a transmission speed, a modulation format, and path switching, wherein each control parameter is software-defined.

3. The SDN method of claim 1, wherein the transmitting of the control command comprises:
detecting the traffic request of the one or more nodes by monitoring the traffic flow;
defining, based on software, the control parameter in response to the detected traffic request; and
generating the control command based on the software-defined control parameter and transmitting the generated control command to the one or more nodes through the control channel by using an OpenFlow Application Programming Interface (API).

4. The SDN method of claim 3, wherein the defining of the control parameter based on software comprises defining each control parameter based on software in accordance with the traffic request of a node and a traffic flow of an entire network.

5. The SDN method of claim 1, wherein the executing of the control command comprises:
the OpenFlow API receiving the control command from the control device and converting the received control command into a programmable language; and
controlling operations of hardware related to the converted control command through firmware.

6. The SDN method of claim 1, wherein the transmitting of the control command comprises the control device transmitting the control command to each of the one or more nodes through the control channel by using the OpenFlow; and
the executing of the control command comprises each of the one or more nodes receiving the control command from the control device and executing the received control command.

7. The SDN method of claim 1, wherein the transmitting of the control command comprises:
the control device transmitting the control command to a first node through the control channel by using the OpenFlow; and
the first node receiving the control command from the control device and transmitting the received control command to a second node through the control channel; and
the executing of the control command comprises:
the first node receiving the control command from the control device and executing the received control command; and
the second node receiving the control command from the first node and executing the received control command.

8. The SDN method of claim 7, wherein the control channel between each of the one or more nodes is a channel whose physical path is independently separated from a data transfer channel, or whose physical path is the same as the data transfer channel but logical path is separated from the data transfer channel.

9. The SDN method of claim 8, wherein the control channel whose physical path is the same as the data transfer channel but logical path is separated from the data transfer channel is configured to assign, to the control channel, physical layer network resources within the physical path.

10. An SDN method in a fixed mobile convergence subscriber network, the SDN method comprising:
a control device transmitting a control command, comprising:
defining a control parameter based on software in response to a traffic request of a subscriber terminal device by monitoring a traffic flow, and transmitting a control command with respect to the software-defined control parameter to a device of a central base station through a control channel by using OpenFlow;
the device of a central base station transmitting the control command received from the control device to each subscriber terminal device of a wired or wireless form through distribution of network resources; and
the subscriber terminal device receiving the control command from the device of a central base station and executing the received control command.

11. The SDN method of claim 10, wherein the control parameter has different types in accordance with types of a distribution network and is software-defined.

12. The SDN method of claim 11, wherein the control parameter comprises:
a time slot, a modulation format, and a forward error correction (FEC) code in a case of a time-division multiplexing-passive optical network (TDM-PON);
a wavelength, a modulation format, and a wavelength interval in a case of a wavelength-division multiplexing-PON (WDM-PON); and
is an OFDM sub-carrier, a modulation format, and a fast-Fourier transform (FFT) size and bandwidth in a case of an orthogonal frequency-division multiplexing (OFDM-PON).

13. The SDN method of claim 10, wherein the transmitting of the control command comprises:
detecting the traffic request by monitoring a traffic flow of each subscriber terminal device connected to a distribution network;
defining, based on software, the control parameter in response to the detected traffic request; and
generating the control command based on the software-defined control parameter to transmit the generated control command to the device of a central base station through the control channel by using OpenFlow API.

14. The SDN method of claim 10, wherein the control device and the device of a central base station are connected through the control channel that is separate, and the device of a central base station and each subscriber terminal device are connected through a control channel whose physical path is the same but logical path is separated.

15. The SDN method of claim 14, wherein the control channel whose physical channel is the same but logical path is separated is configured to assign, to the control channel, physical layer network resources within the physical path.

16. An SDN method in a mobile communications base station network based on analog wireless-optical transmission, the SDN method comprising:
a control device transmitting a control command to a digital unit (DU), comprising:
defining a control parameter based on software in response to a traffic request of a radio unit (RU) by monitoring a traffic flow, and transmitting a control command with respect to the software-defined control parameter to the DU through a control channel by using OpenFlow;
the DU transmitting the control command received from the control device to each RU, converting a digital baseband signal to an analog signal in accordance with the control command, shifting upward the converted digital baseband signal to an intermediate frequency (IF) signal, multiplexing the IF signal, and transmitting the multiplexed IF signal to each RU; and
each RU receiving and executing the control command, extracting the IF signal from the multiplexed IF signal received from the DU in response to the control command, converting the extracted IF signal into a high frequency signal, and transmitting the converted IF signal to free space.

17. A SDN method of claim 16, wherein a number of the RUs that are acceptable by a single DU is acquired by multiplying a number of acceptable wavelengths and IF signals capable for being multiplexed for each wavelength.

18. The SDN method of claim 16, wherein the control parameter is related to physical layer transmission, including at least one of a wavelength, an IF, a modulation method, a channel bandwidth, and an OFDM, wherein each control parameter is software-defined.

19. The SDN method of claim 16, wherein the control device and the DU are connected through the control channel that is separate, and the DU and each RU are connected through a control channel whose physical path is the same but logical path is separated.

20. The SDN method of claim 19, wherein the control channel whose physical channel is the same but logical path is separated is configured to assign, to the control channel, physical layer network resources within the physical path.
